(19) United States
(12) Patent Application Publication
(10) Pub. No.: US 2024/0205777 A1
(43) Pub. Date: Jun. 20, 2024

(54) METHOD AND DEVICE FOR CATEGORISING DATA STREAMS PASSING BETWEEN A STATION AND AN ACCESS POINT SERVING THE STATION

(71) Applicant: SAGEMCOM BROADBAND SAS, Bois-Colombes (FR)

(72) Inventors: Sylvain LE ROUX, Bois-Colombes (FR); Madhi BAKLOUTI, Bois-Colombes (FR); Jean-Philippe JAULIN, Bois-Colombes (FR); Lalam MASSINISSA, Bois-Colombes (FR)

(73) Assignee: SAGEMCOM BROADBAND SAS, Bois-Colombes (FR)

(21) Appl. No.: 18/523,391

(22) Filed: Nov. 29, 2023

(30) Foreign Application Priority Data
Dec. 16, 2022 (FR) 2213525

(51) Int. Cl. H04W 36/26; H04W 36/08

(52) U.S. Cl. CPC H04W 36/26; H04W 36/08

(57) ABSTRACT

A methods/devices are provided for categorizing data streams passing between a station and an access point serving the station to determine whether the station can change access point serving it. The access point serving at least one station: identifies, from an identifier of the source and/or from the destination of the data, each data stream passing between the station and the access point, measures, for each data stream, the quantity of data passing between the station and the access point, calculates, for each data stream, a mean from the measurements for the stream, categorizes each data stream as an interruptible data stream if the mean of the data streams is lower than a first predetermined threshold, and determines that the station can be served by another access point if each stream passing between the station and the access point is categorized as an interruptible data stream.

### TECHNICAL FIELD

The present invention relates to a method and a device for categorising data streams passing between a station and an access point serving the station to determine whether the station served by the node access point can change access point serving it.

### PRIOR ART

In local area networks (LAN), systems for extending wireless communication coverage can be used in order to increase the range of these local area networks LAN by coordinating a plurality of distributed access points AP. These various access points AP are incorporated in communication nodes, hereinafter simply referred to as nodes, and all make available one and the same wireless local area network WLAN.

The nodes of the backhaul subnetwork are connected to one another by means of a mesh structure in tree form, a node then being able to serve as relay between two other nodes of the backhaul subnetwork. The nodes of the backhaul subnetwork are thus interconnected by means of wire connections, for example of the Ethernet type, or wireless connections, for example of the Wi-Fi type. The nodes of the backhaul subnetwork are connected together by a network that is also called “backhaul network”, which may be either wire, or wireless, or a combination of the two.

Each node of the backhaul subnetwork optionally sends at least one wireless network that is called fronthaul network, to which the stations of the user are connected. This fronthaul network, if it uses Wi-Fi/IEEE 802.11 technology, is equivalent to what is called BSS (Basic Service Set).

At least one of the nodes of the backhaul subnetwork is connected to a residential gateway that provides access to the internet. The residential gateway may also form part of the backhaul subnetwork.

The access-point handover mechanism consists in moving a communication connection established between a station and an access point to another access point judged to be more suitable for providing communication with the station.

This mechanism is known and has been widely used in all wireless telecommunications for many years.

The structure of the interfaces of the local area networks using radio communication technology of the Wi-Fi type does not enable a station to be in communication simultaneously with more than one access point possibly included in various nodes.

This limitation means that a handover implicitly causes a temporary break in the transfer of data between the station and the access point because of the need to disconnect the access point, to reconfigure the interface of the station and to connect to the new access point. Conventionally, stations comprise a buffer that stores the data loaded in advance before use thereof to provide a solution to a break, or when the download speed of the data is below the speed of consumption thereof by the application in question.

Nevertheless, this solution is not optimum since it may still produce an artefact in the communication, such as a parasite in a sound reproduced by the station, the appearance of a macroblock on a screen of the station, or a loss of command of a game.

### DISCLOSURE OF THE INVENTION

The present invention makes it possible to guarantee that the stations that are connected to an access point of a node do not suffer an artefact in a communication when a handover of the station is implemented.

For this purpose, according to a first aspect, one embodiment proposes a method for categorizing data streams passing between a station and an access point serving the station to determine whether the station served by the access point can change access point serving it, the access point being included in a node forming part of a local area network comprising a plurality of nodes allowing an extension of wireless communication coverage in order to increase the range of the local area network by coordinating a plurality of access points incorporated in the nodes, characterized in that the method comprises the steps, performed by the access point serving at least one station, of:
identifying, from an identifier of the source and/or from the destination of the data, each data stream passing between the station and the access point,
measuring, for each data stream, the quantity of data passing between the station and the access point,
calculating, for each data stream, a mean from the measurements for the stream,
categorizing each data stream as an interruptible data stream if the mean of the data streams is lower than a first predetermined threshold,
determining that the station served by the access point can be served by another access point if each stream passing between the station and the access point is categorized as an interruptible data stream.

One embodiment also relates to a device for categorizing data streams passing between a station and an access point serving the station to determine whether the station served by the access point can change access point serving it, the access point being included in a node forming part of a local area network comprising a plurality of nodes allowing an extension of wireless communication coverage in order to increase the range of the local area network by coordinating a plurality of access points incorporated in the nodes, characterized in that the device is included in the access point serving the station, and comprises:
means for identifying, from an identifier of the source and/or from the destination of the data, each data stream passing between the station and the access point,
means for measuring, for each data stream, the quantity of data passing between the station and the access point,
means for calculating, for each data stream, a mean from the measurements for the stream,
means for categorizing each data stream as an interruptible data stream if the mean of the data stream is lower than a first predetermined threshold,
means for determining that the station served by the access point can be served by another access point if each stream passing between the station and the access point is categorized as an interruptible data stream.

Thus, by performing statistical operations on the data stream, it is possible to categorize each data stream, to limit the parasitic effects related to an inappropriate break in a data stream considered to be non-interruptible and to limit handovers to the non-critical streams and to the situations that are strictly necessary.

According to a particular embodiment, the method further comprises the steps performed, if the mean of at least one data stream is higher than the first predetermined threshold, of:
calculating, for each data stream the mean of which is higher than or equal to the first predetermined threshold, a standard deviation from the measurements for the stream,
calculating, for each data stream the mean of which is higher than or equal to the first predetermined threshold, a score from the mean and from the standard deviation of the data stream,
categorizing each data stream the mean of which is higher than the first predetermined threshold as a non-interruptible data stream if the score of the data stream is lower than a second predetermined threshold,
determining that a station served by the access point must not be served by another access point if at least one stream passing between the station and the access point is categorised as a non-interruptible data stream.

According to a particular embodiment, the method further comprises the steps of:
categorizing each data stream the mean of which is higher than the first predetermined threshold as an interruptible data stream if the score of the data stream is higher than or equal to a second predetermined threshold,
determining that a station served by the access point can be served by another access point if each stream passing between the station and the access point is categorised as an interruptible data stream.

According to a particular embodiment, each score is calculated using the following formula:

SC(t)=σ(t)/(K+mean(t))

where mean(t) is the mean, SC(t) is the score, σ(t) is the standard deviation and K a value strictly greater than 0.

According to a particular embodiment, each mean is calculated for a first predetermined period of time.

According to a particular embodiment, each standard deviation and each score are calculated for the first predetermined period of time.

According to a particular embodiment, each mean, each standard deviation and each score are calculated with a predetermined periodicity.

A particular embodiment also relates to a computer program product. It comprises instructions for implementing, by an item of equipment, the method according to one of the above embodiments, when said program is executed by a processor of the equipment.

A particular embodiment also relates to a storage medium. It stores a computer program comprising instructions for implementing, by a node device, the method according to one of the above embodiments, when said program is executed by a processor of the node device.

### BRIEF DESCRIPTION OF THE DRAWINGS

The features of the invention mentioned above, as well as others, will emerge more clearly from the reading of the following description of an example embodiment, said description being made in relation to the accompanying drawings, among which:

FIG. 1 illustrates schematically an example of a local area network in one embodiment:

FIG. 2 illustrates schematically the architecture of a node according to one embodiment:

FIG. 3 illustrates an example of a method implemented by an access point of a node according to one embodiment:

FIG. 4a illustrates an example of measurements in a sliding window of the quantity of data of a data stream passing between a station served by a node in a case where the data stream is considered to be interruptible:

FIG. 4b illustrates an example of scores calculated from the quantity of data of a data stream passing in a sliding window between a station served by a node in a case where the data stream is considered to be interruptible:

FIG. 5a illustrates an example of measurements in a sliding window of the quantity of data of a data stream passing between a station served by a node in a case where the data stream is considered to be non-interruptible:

FIG. 5b illustrates an example of scores calculated from the quantity of data of a data stream passing in a sliding window between a station served by a node in a case where the data stream is considered to be non-interruptible:

FIG. 6a illustrates an example of measurements in a sliding window of the quantity of data of a data stream passing between a station served by a node in a situation in which the data stream varies between an interruptible and a non-interruptible categorization:

FIG. 6b illustrates an example of scores calculated from the quantity of data of a data stream passing in a sliding window between a station served by a node in a situation in which the data stream varies between an interruptible and a non-interruptible categorization.

### DETAILED DISCLOSURE OF EMBODIMENTS

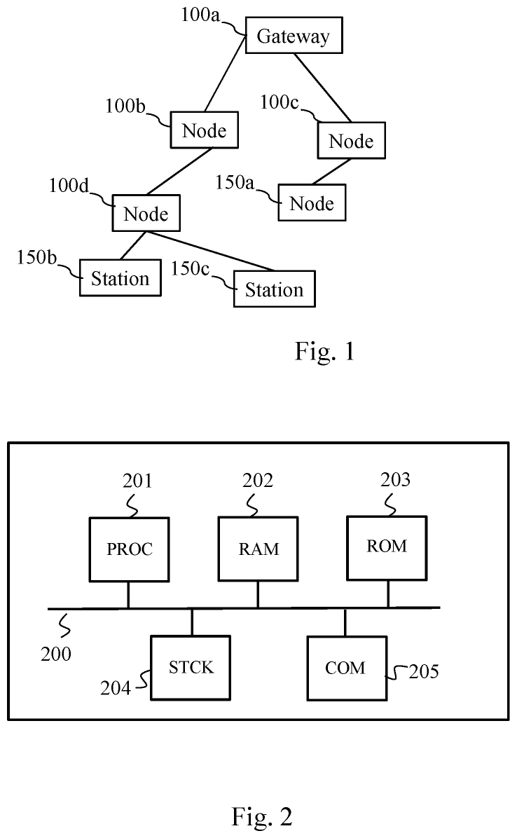

FIG. 1 illustrates an example of a local area network in one embodiment.

The mesh local area network is constructed around a backhaul subnetwork comprising a set of interconnected nodes 100a to 100d.

The node 100a is for example a residential gateway that provides access to a wide area network, such as for example the internet.

The nodes 100b to 100d are systems for extending wireless communication coverage that are used in order to increase the range of the local area network by coordinating a plurality of distributed access points AP. These various access points AP are incorporated in the nodes that are interconnected by means of a backhaul subnetwork and all make available one and the same wireless local area network WLAN. In one example, the nodes 100b, 100c and 100d are wireless coverage extenders. In another example, the various access points, or a subset of these access points, all make available at least two same wireless local area networks WLAN. One of these networks can correspond to a private wireless network WLAN for known stations of said network, while the other corresponds to a public or invited wireless network WLAN.

The node 100a may be included in the backhaul subnetwork.

The nodes 100a to 100d of the backhaul subnetwork are connected to one another by means of a mesh structure in tree form, a node then being able to serve as relay between two other nodes of the backhaul subnetwork. The nodes of the backhaul subnetwork are for example interconnected by means of wireless connections.

Each node of the backhaul subnetwork sends at least one wireless network that is called fronthaul network, to which the stations of the user are connected. This fronthaul network, if it uses Wi-Fi/IEEE 802.11 technology, is equivalent to what is called BSS (Basic Service Set).

In the example in FIG. 1, the node 100a is connected to the nodes 100b and 100c, and the node 100b is interconnected to the node 100d.

The stations 150b and 150c are served by the node 100d and the station 150a is served by the node 100c.

Hereinafter the term “station” should be understood to mean fixed or mobile equipment using the resources of the mesh local area network via nodes of said local area network. In various examples, the equipment, nodes or stations are respectively each compatible with one or more standards in the IEEE 802.11 family of standards.

The stations are for example smartphones or a tablet, a computer, a television, or a network attached storage (NAS) unit.

FIG. 2 illustrates schematically the architecture of a node comprising an access point according to one embodiment.

According to the example of hardware architecture shown in FIG. 2, the nodes 100a to 100d comprise, connected by a communication bus 200: a processor or CPU (“central processing unit”) 201: a random access memory (RAM) 202: a read only memory (ROM) 203: a storage unit such as a hard disk (or a storage medium reader, such as an SD (Secure Digital) card reader 204; at least one communication interface 205 enabling the node to communicate with the equipment of the local area network.

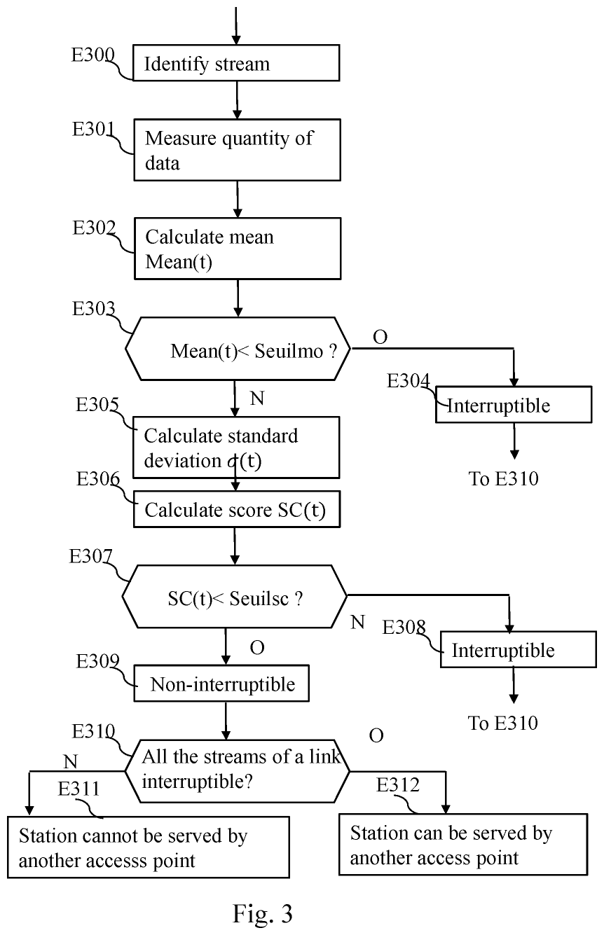

The processor 201 is capable of executing instructions loaded in the RAM 202 from the ROM 203, from an external memory (not shown), from a storage medium (such as an SD card), or from a communication network. When the node is powered up, the processor 201 is capable of reading instructions from the RAM 202 and executing them. These instructions form a computer program causing the implementation, by the processor 201, of all or part of the method described in relation to FIG. 3.

The method described below in relation to FIG. 3 can be implemented in software form by executing a set of instructions by a programmable machine, for example a DSP (“digital signal processor”), or a microcontroller, or be implemented in hardware form by a machine or a dedicated component, for example an FPGA (field-programmable gate array) or an ASIC (application-specific integrated circuit). In general, the node comprises electronic circuitry configured for implementing the methods described in relation to FIG. 3. FIG. 3 illustrates an example of a method implemented by an access point of a node according to one embodiment.

At the step E300, the access point identifies, from an identifier of the source and/or from the destinations of the data, each data stream passing between the access point and each station served by the access point. All the data streams passing between the access point and a station are hereinafter referred to as the link between the access point and the station. For example, the access point identifies the data intended for and/or sent by each station that it serves from the MAC address included in the data or from an address identifying each application of the station sending or receiving the data.

The identification can be made unidirectionally or bidirectionally.

At the step E301, the access point measures, for each data stream, the quantity of data passing between the station and the access point.

For example, the access point periodically obtains, in accordance with a period P of between 1 and 10 seconds, more particularly a period P equal to 5 seconds, the quantity of bytes Δ(t) that have passed in each stream during a period t. By obtaining the total number of bytes that have passed since the data stream was established periodically and by taking the difference between the two consecutive values, the number of bytes that have passed in the data stream in the interval of time P separating two consecutive instants is obtained.

At the step E302, the access point calculates, for each stream, a mean mean(t) from the numbers of bytes obtained for the stream. The mean is calculated over a sliding window of a few periods (10 periods for example) to obtain the mean number of bytes passing in the stream.

At the step E303, the access point compares, for each data stream, the mean with a first predetermined threshold denoted Seuilmo. The first predetermined threshold is for example between 5000 and 8000 bytes per period P.

For each stream, if the mean of the data stream is lower than the first predetermined threshold, the access point passes to the step E304 and categorizes the data stream as an interruptible data stream. Once this operation has been performed, the access point passes to the step E310.

If the mean of at least one data stream is higher than or equal to the first predetermined threshold, the access point passes to the step E305.

At the step E305, the access point calculates, for each data stream the mean of which is higher than or equal to the first predetermined threshold, a standard deviation over the same sliding window as the mean. The standard deviation characterizes the stability of the traffic in the stream over time. A low value of standard deviation shows a stream that is relatively stable over time. The value thus obtained is denoted ø(t).

At the step E306, the access point calculates, for each data stream the mean of which is higher than the first predetermined threshold, a score from the mean and from the standard deviation of the data stream.

Each score is calculated using the following formula:

SC(t)=σ(t)/(K+mean(t))

where SC(t) is the score, σ(t) is the standard deviation and K a value strictly greater than 0, for example equal to 0.5 or 1.

At the step E307, the access point compares, for each data stream where the mean of the data stream is higher than or equal to the first predetermined threshold, the score SC(t) at a second predetermined threshold called Seuilsc. The second predetermined threshold is for example between 0.45 and 0.55.

For each stream where the mean of the data stream is higher than or equal to the first predetermined threshold and the score is lower than or equal to the second predetermined threshold, the access point passes to the step E309 and categorizes the data stream as a non-interruptible data stream. Once this operation has been performed, the access point passes to the step E310.

For each stream where the mean of the data stream is higher than or equal to the first predetermined threshold and the score is higher than the second predetermined threshold, the access point passes to the step E308 and categorizes the data stream as an interruptible data stream. Once this operation has been performed, the access point passes to the step E310.

At the step E310, the access point checks whether all the data streams of a link are interruptible. If all the data streams of a link are interruptible, the access point passes to the step E312. If at least one data stream of a link is non-interruptible, the access point passes to the step E311. At the step E311, the access point determines that a station served by the access point must not be served by another access point if at least one data stream of the link between the station and the access point is categorized as a non-interruptible data stream.

At the step E308, the access point determines that a station served by the access point can be served by another access point if each data stream of the link between the station and the access point is categorized as an interruptible data stream.

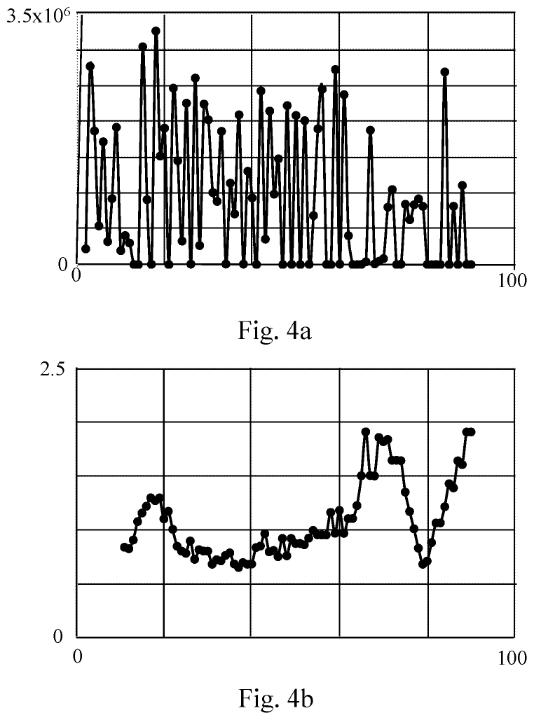

FIGS. 4a and 4b illustrate respectively an example of measurements over a sliding window of the quantity of data Δ(t) of a data stream passing between a station served by a node and of scores SC(t) in a case where the data stream is considered to be interruptible.

The interruptible data streams are for example an audiovisual streaming reading or a browsing on the internet.

As shown in FIGS. 4a and 4b, interruptible data streams are mainly characterized by a throughput that is highly variable over time, giving rise to quantities of data Δ(t) that are highly variable over time. This is because they consist of bursts during which the throughput is high, or even very high, separated by periods where the throughput is very low; or even zero. These bursts enable memories to be filled (for example in the case of traffic of the streaming type) or an element to be loaded (for example when results are loaded following a request on a search engine).

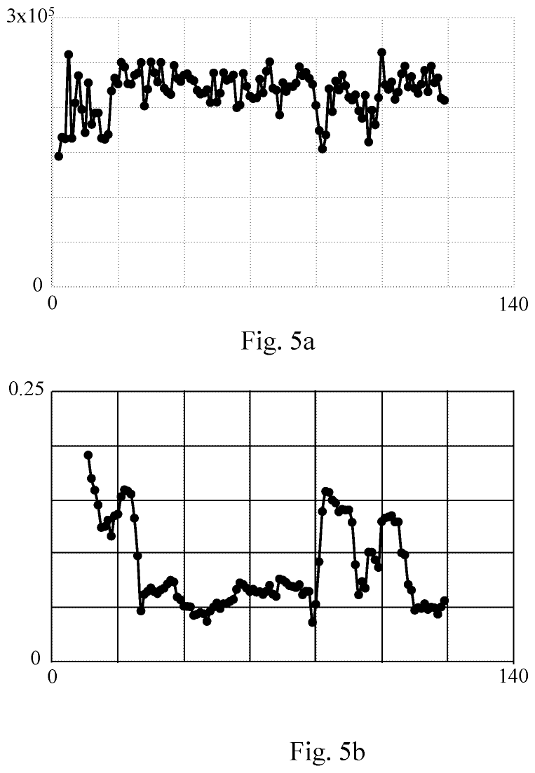

FIGS. 5a and 5b illustrate respectively an example of measurements over a sliding window of the quantity of data Δ(t) of a data stream passing between a station served by a node and of scores SC(t) in a case where the data stream is considered to be non-interruptible.

Non-interruptible data streams are for example data streams of a telephone conversation, or of a videoconference, or of interactive video games.

As shown in FIGS. 5a and 5b, non-interruptible data streams are mainly characterized by a throughput that is very stable over time and not too low. This is because the traffic to be sent (or received) is generated over time and cannot be anticipated. It must therefore be sent as soon as it is generated.

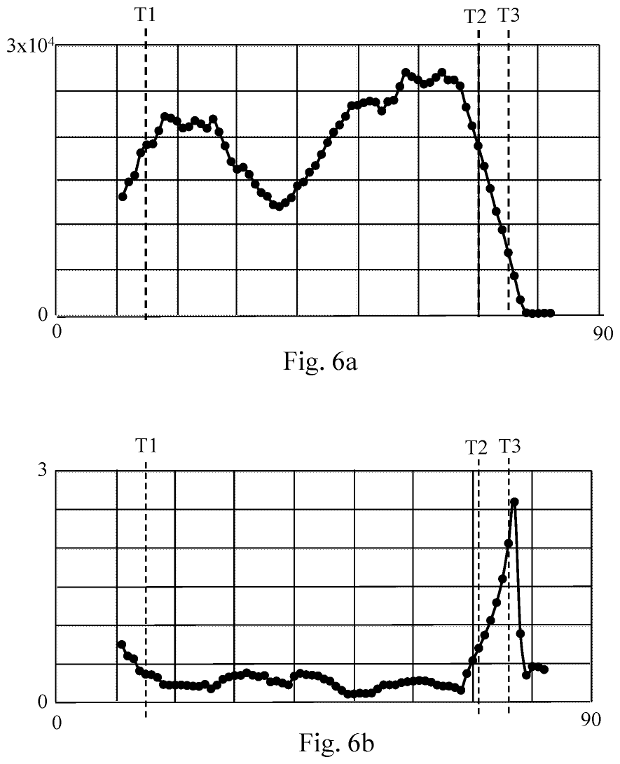

FIGS. 6a and 6b illustrate respectively an example of measurements over a sliding window of the quantity of data Δ(t) of a data stream passing between a station served by a node in a situation and with scores SC(t) in which the data stream varies between an interruptible and a non-interruptible categorization.

A station can in the course of time receive or send interruptible and non-interruptible data streams.

As shown in FIGS. 6a and 6b, the data stream for a station is initially interruptible (t<T1) because of the score higher than the second predetermined threshold. The data stream for the station then becomes non-interruptible between T1 and T2, still because of the threshold, which is this time lower than the second predetermined threshold, in order finally once again to become interruptible because of the mean, which becomes lower than the first predetermined threshold.

1. A method for categorizing data streams passing between a station and an access point serving the station to determine whether the station served by the access point can change access point serving it, the access point being included in a node forming part of a local area network comprising a plurality of nodes allowing an extension of wireless communication coverage in order to increase the range of the local area network by coordinating a plurality of access points incorporated in the nodes, wherein the method comprises the steps, performed by the access point serving at least one station, of:
identifying, from an identifier of the source and/or from the destination of the data, each data stream passing between the station and the access point,
measuring, for each data stream, the quantity of data passing between the station and the access point,
calculating, for each data stream, a mean from the measurements for the stream,
categorizing each data stream as an interruptible data stream if the mean of the data streams is lower than a first predetermined threshold,
determining that the station served by the access point can be served by another access point if each stream passing between the station and the access point is categorized as an interruptible data stream.

2. The method according to claim 1, wherein the method further comprises the steps performed, if the mean of at least one data stream is higher than the first predetermined threshold, of:
calculating, for each data stream the mean of which is higher than or equal to the first predetermined threshold, a standard deviation from the measurements for the stream,
calculating, for each data stream the mean of which is higher than or equal to the first predetermined threshold, a score from the mean and from the standard deviation of the data stream,
categorizing each data stream the mean of which is higher than the first predetermined threshold as a non-interruptible data stream if the score of the data stream is lower than a second predetermined threshold,
determining that a station served by the access point must not be served by another access point if at least one stream passing between the station and the access point is categorized as a non-interruptible data stream.

3. The method according to claim 2, wherein the method further comprises the steps of:
categorizing each data stream the mean of which is higher than the first predetermined threshold as an interruptible data stream if the score of the data stream is higher than or equal to a second predetermined threshold,
determining that a station served by the access point can be served by another access point if each stream passing between the station and the access point is categorized as an interruptible data stream.

4. The method according to claim 2, wherein each score is calculated using the following formula:
SC(t)=σ(t)/(K+mean(t))
where mean(t) is the mean, SC(t) is the score, σ(t) is the standard deviation and K a value strictly greater than 0.

5. The method according to claim 1, wherein each mean is calculated for a first predetermined period of time.

6. The method according to claim 2, wherein each standard deviation and each score are calculated for the first predetermined period of time.

7. The method according to claim 6, wherein each mean, each standard deviation and each score are calculated with a predetermined periodicity.

8. A device for categorizing data streams passing between a station and an access point serving the station to determine whether the station served by the access point can change access point serving it, the access point being included in a node forming part of a local area network comprising a plurality of nodes allowing an extension of wireless communication coverage in order to increase the range of the local area network by coordinating a plurality of access points incorporated in the nodes, wherein the device is included in the access point serving the station, and comprises:
means for identifying, from an identifier of the source and/or from the destination of the data, each data stream passing between the station and the access point,
means for measuring, for each data stream, the quantity of data passing between the station and the access point,
means for calculating, for each data stream, a mean from the measurements for the stream,
means for categorizing each data stream as an interruptible data stream if the mean of the data streams is lower than a first predetermined threshold,
means for determining that the station served by the access point can be served by another access point if each stream passing between the station and the access point is categorized as an interruptible data stream.

9. (canceled)

10. A non-transitory storage medium storing a computer program comprising instructions for implementing, by an item of equipment, the method according to claim 1, when said program is executed by a processor of a node.
